(19) United States
(12) Patent Application Publication
(10) Pub. No.: US 2004/0098412 A1
(43) Pub. Date: May 20, 2004

(54) System and method for clustering a set of records

(75) Inventor: Stefan Raspl, Tamm (DE)

Correspondence Address: Samuel A. Kassatly, 6819 Trinidad Drive, San Jose, CA, 95120, US

(73) Assignee: International Business Machines Corporation, Armonk, NY

(21) Appl. No.: 10/700,908

(22) Filed: Nov. 3, 2003

(30) Foreign Application Priority Data
Nov. 19, 2002 (EP) 02025847.1

(51) Int. Cl. G06F 17/00

(52) U.S. Cl. 707/104.1

(57) ABSTRACT

A record clustering system provides a computationally inexpensive method of accurately clustering data records containing structured raw data requiring only two passes over the data. Each data record contains a sequence of attribute values of corresponding attributes. For each attribute, a characteristic value is calculated by evaluating the attribute values of that attribute across the data records. For each attribute value, a deviation from the corresponding characteristic value is calculated. The attributes of each record are sorted based on the deviations to provide a sequence of attributes used as a key for clustering. A user may select criteria for evaluation of the keys for clustering of the data records. The clustering result is refined by searching of best matching keys in other clusters for the records of the smallest cluster. In this manner, the records contained in the smallest cluster are distributed to other clusters, reducing the total number of clusters.

### FIELD OF THE INVENTION

The present invention relates to the field of data processing, and more particularly to the field of data clustering. Specifically, the present invention relates to a computationally inexpensive method of accurately clustering data records containing structured raw data that requires only two passes over the data

### BACKGROUND OF THE INVENTION

Clustering of data is a data processing task in which clusters are identified in a structured set of raw data. Typically, the raw data comprises a large set of records, each record having the same or a similar format. Each field in a record can take any of a number of logical, categorical, or numerical values. Data clustering aims to group such records into clusters such that records belonging to the same cluster have a high degree of similarity.

Numerous data clustering algorithms are known. The K-means algorithm relies on the minimal sum of Euclidean distances to the center of clusters, taking into consideration the number of clusters. The Kohonen-algorithm is based on a neural net and also uses Euclidean distances. IBM's demographic algorithm relies on the sum of internal similarities minus the sum of external similarities as a clustering criterion. Those and other clustering criteria are utilized in an iterative process of finding clusters.

A common disadvantage of such conventional clustering methods is that they are computationally expensive and require a great deal of computing power. This is especially true for very large data sets.

Although this technology has proven to be useful, it would be desirable to present additional improvements. What is therefore needed is a system, a computer program product, and an associated method for an improved method of clustering that requires less computing power. The need for such a solution has heretofore remained unsatisfied.

### SUMMARY OF THE INVENTION

The present invention satisfies this need, and presents a system, a computer program product, and an associated method (collectively referred to herein as “the system” or “the present system”) for a computationally inexpensive method of accurately clustering of data records containing structured raw data.

Each of the data records contains a sequence of attribute values of corresponding attributes. For each of the attributes of the structured set of raw data contained in the records, a characteristic value is calculated by evaluating the attribute values of that attribute across the data records. For each of the attribute values, a deviation from the corresponding characteristic value is calculated. The attributes of each record are sorted based on the deviations to provide a sequence of attributes that is then used as a key for clustering.

The mean value or the median value of the attribute values of a certain attribute across the data records is calculated to provide the characteristic value.

The deviation of an attribute value is calculated by determining the difference between the attribute value and the corresponding characteristic value. The difference may then be normalized by dividing by that characteristic value.

The attributes of a record are sorted using the corresponding deviations for the evaluation of a sorting criterion. For example, the attributes with their corresponding deviations are sorted in ascending or descending order. The same sorting criterion may be applied for all considered records.

The clustering is performed based on the keys provided by sorting the attributes of the records. A user may select a criterion of a given number of criteria for evaluation of the keys for clustering of the data records. For example, all data records that have the same first “m” attributes are placed in the same cluster regardless of the sign of the deviations.

The clustering result is refined by searching of best matching keys in other clusters for the records of the smallest cluster. In this manner, the records contained in the smallest cluster are distributed to other clusters such that the total number of clusters is reduced. For identification of other clusters for a record in the smallest cluster, a distance measure such as a Euclids distance may be utilized.

In addition, or as an alternative to Euclids distance, gravitation may be used for reducing the number of clusters. Reference is made to the following Web site: http://www.ticam.utexas.edu/˜zeyun/pick.htm.

The present system is particularly advantageous in that it provides an efficient and computationally inexpensive way to analyze the characteristics of unknown data. Furthermore, performance of the clustering method requires only two passes over the data.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a process flow chart illustrating a method of the record clustering system of the present invention; and

FIG. 2 is a schematic illustration of an exemplary operating environment in which a record clustering system of the present invention can be used.

### DETAILED DESCRIPTION OF PREFERRED EMBODIMENTS

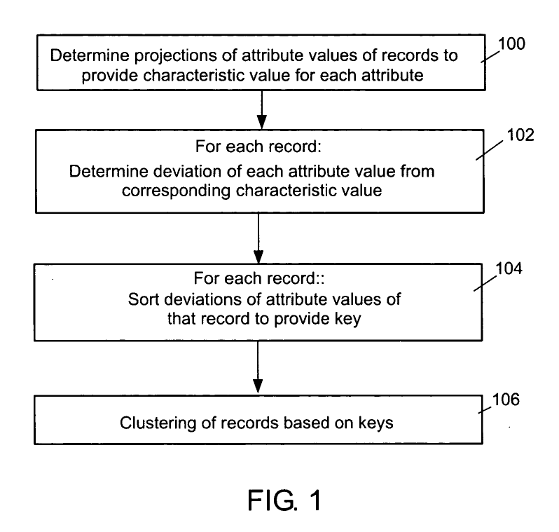

FIG. 1 shows a process flow chart for performing a method of clustering of data records containing structured raw data. Given are n records r₁, . . . , rₙ with k numeric attributes a₁ . . . , aₖ, where aᵢ(rⱼ) is the value of the i-th attribute of the j-th record. In step 100, a characteristic value is calculated for each of the attributes. For a given attribute this characteristic value is calculated by determining a projection of the attribute values of this attribute across the records.

For example, the mean value is calculated as a characteristic value for each one of the attributes. For each attribute a_{I}, I=1, . . . , k, calculate the mean value μ over all records as follows:

$$μ ( {a}_{l} ) = \frac{1}{n} {\sum }_{i = 1}^{n} {a}_{l} ( {r}_{i} ) \qquad ( 1 )$$

Instead of the mean values, the median values can be calculated. The median value is calculated by determining the difference between a maximum attribute value of a considered attribute and a minimum attribute value of the considered attribute over all records divided by two. Alternatively, any other equivalent of a mean or median value may be calculated instead. By means of such mean values, median values or equivalent values characteristic values are provided for each of the attributes.

In step 102, the deviations of each attribute value of a considered record from the corresponding characteristic value are determined. For example, the deviation of an attribute value from its characteristic value can be performed by calculating the difference between the attribute value and its characteristic value. The difference may be divided by the characteristic value.

In step 104, the deviations that have been obtained for each of the records are used as a basis for sorting the attributes of this record. For example, the attributes are sorted in ascending or descending order of the deviations. In this manner, a key comprising an ordered list of attributes and associated deviations is provided for each one of the records.

Steps 102 and 104 may be carried out as follows:

Consider record rᵢ.

Consider attribute aⱼ.

Calculate the deviation âⱼ(rᵢ) of aⱼ(rᵢ) from the respective mean of attribute aⱼ using the following deviation formula:

$${\hat{a}}_{j} ( {r}_{i} ) = \frac{{a}_{j} ( {r}_{i} ) - μ ( {a}_{j} ( {r}_{i} ) )}{μ ( {a}_{j} ( {r}_{i} ) )} \qquad ( 2 )$$

The present system is not limited to this deviation formula; any other deviation formula may be used.

Repeat the two preceding steps for all attributes aᵢ, . . . , aₖ of the record rᵢ.

Rank the deviations |â₁(rᵢ)|, . . . ,|âₖ(rᵢ)|from the largest to the smallest, holding \hat{α}ₗ_{₁} (rᵢ), . . . , \hat{α}ₗ_{ₖ}(rᵢ). This ranking shows which attributes deviate the most from the mean of all records. For example, since âₗ₁(rᵢ) has the largest deviation from the respective mean value μ(αₗ_{₁}), record rᵢ differs the most from all other records by attribute αₗ_{₁}. The largest value shows the largest deviation from the rest of the data; consequently, that attribute is very characteristic.

In step 106, the records are clustered based on the keys.

A method for performing the clustering based on the keys is to place records having identical keys into the same cluster. However, this may result in a number of clusters that is too large. Consequently, a similarity criterion is defined such that when the keys of two records fulfil the similarity criterion, the records are put into the same cluster:

Let \hat{α}ₗ_{₁}(rᵢ), . . . , \hat{α}ₗ_{ₖ}(rᵢ) be the ranking, i.e. the key, of record rᵢ and \hat{α}ₗ_{₁}(rⱼ), . . . , \hat{α}ₗ_{ₖ}(rⱼ) be the ranking of record rⱼ.

Some examples of similarity criteria are criterion A, criterion B, and criterion C.

Criterion A: rᵢ and rⱼ belong to the same cluster if the first m attributes of the respective keys are identical and share the same sign. For example, if the three most significant attributes (m=3) are considered, the ranking of record rᵢ is as follows:

(â₇(rᵢ), â₂(rᵢ), â₃(rᵢ), â₉(rᵢ), . . . )=−1.17, 0.95, 0.87, 0.56, . . .

and the ranking of rⱼ is

(â₇(rᵢ), â₂(rⱼ), â₃(rᵢ),â₁(rⱼ), . . . )=−1.46, 1.09, 0.89, 0.88, . . .

The records rᵢ and rⱼ belong to the same cluster, as the first three attributes of the keys are identical as well as the signs of the values.

However, if the ranking of rₖ was (â₇(rₖ), â₂(rₖ), a\hat{3}(rₖ), . . . )=−1.46, −1.09, 0.89, 0.88, . . . , the rᵢ and rₖ would belong to different sections because the signs of the second most distinguishing attribute a₂ had a different sign compared to the respective value of record rᵢ.

Criterion B: rᵢ and rⱼ belong to the same cluster if the first m attributes are identical. For example, considering the previous example, records rᵢ and rₖ would belong to the same section, even though the sign of the second most distinguishing attribute is different.

Criterion C: rᵢ and rⱼ belong to the same section if the same attributes appear on the first m positions with identical signs. This criterion ignores the order in which the attributes appear. For example, if m=3, rᵢ as before and the ranking of rⱼ is â₂(rⱼ), â₃(rⱼ), (â₇(rⱼ), â(rⱼ), . . . ,)=0.72, 0.68, −0.42, 0.37, . . . then a₂, a₃ and a₇ are identical and share the same signs. This criterion can be varied by ignoring the signs.

The resulting clustering may be further refined by reducing the number of the clusters. For example, it may be desirable to dissolve a cluster having a small size, i.e., having a small number of records. This may be accomplished by means of the following iterative process:

Rank the clusters by size.

Select the smallest cluster.

For each record of the cluster, find the one of the larger clusters that matches most of the significant attributes. If more than one cluster should be considered, either choose the largest of these clusters or use some kind of distance measure to find the nearest cluster.

Repeat until the desired number of clusters has been reached or if the similarity of records and clusters is too small.

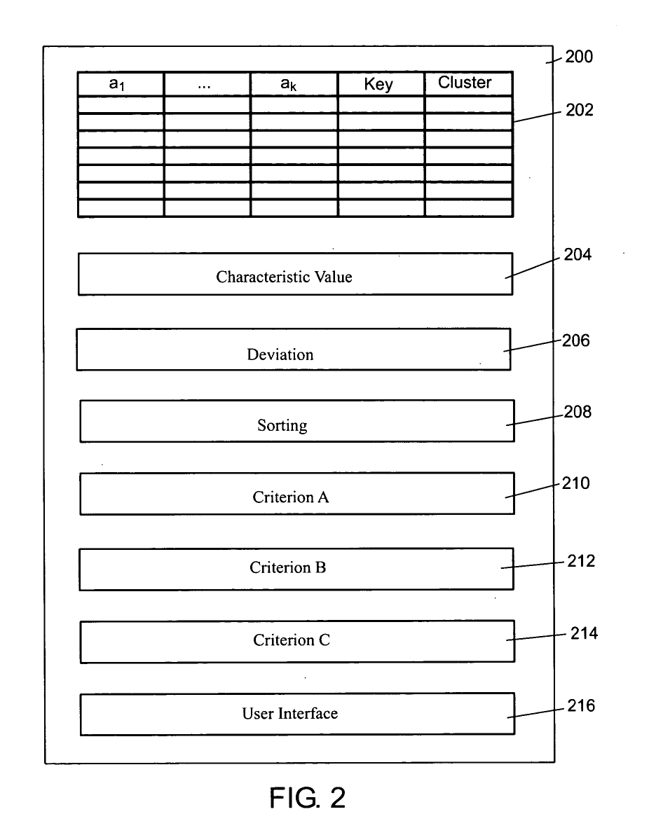

FIG. 2 illustrates a data processing system 200 in which a system and method for clustering a set of records according to the present invention may be used. Data processing system 200 comprises a database 202 for storing records of structured data. Each of the records has attribute values a₁, . . . , aₖ. Each of the records has an associated data field for storing a key for that record and a data field for storing a cluster identifier. Initially the key and cluster data fields are empty.

In addition, data processing system 200 comprises a characteristic value module 204 for calculating of characteristic values for each one of the attributes. The calculation of the characteristic values may be performed as explained with respect to step 100 of FIG. 1.

Further, data processing system 200 comprises a deviation module 206 for calculation of the deviations of the attribute values. This calculation may be performed in accordance with above equation (2).

Sorting module 208 of the data processing system 200 sorts the attributes of the data records by applying a sorting criterion to the deviations of the corresponding attribute values. In this manner, a ranking of the deviations may be obtained for each record. The sorting may be performed as explained with respect to step 104 of FIG. 1.

Further, data processing system 200 comprises criteria A module 210, criteria B module 212 and criteria C module 214 for application of the respective criteria A, B and C. The criteria A, B and C are described above with respect to FIG. 1.

Further, data processing system 200 comprises a user interface 216. By means of the user interface 216, the tabular data contained in database 202 may be visualised. Furthermore, a user may select a subset of the records contained in the database 202 for performing a clustering operation. Before the data clustering is performed, the user selects one of the pre-defined clustering criteria A, B or C. Alternatively, the user may define a user specific clustering criterion.

The data clustering is initiated after the user has selected the set of records of the database 202 on which the data clustering is to be performed and after a criterion for data clustering has been selected or specified.

The characteristic module 204 is invoked to calculate the characteristic values of the attributes. The deviation module 206 is invoked to calculate the deviations of the attribute values from their corresponding characteristic values. By means of sorting module 208, the attributes are sorted to provide a key for each one of the selected records. The desired module for applying the selected criterion is invoked, i.e., criteria A module 210, criteria B module, or criteria C module 214. Alternatively, a user specified module may be invoked to apply the user specified criterion. As a result of the application of the selected or specified criterion, the selected records are clustered. Records that are placed into the same cluster are assigned the same cluster identifier; this cluster identifier is entered into the corresponding data field within database 202.

It is to be understood that the specific embodiments of the present invention that have been described are merely illustrative of certain applications of the principle of the present invention. Numerous modifications may be made to the present system, method, and service described herein without departing from the spirit and scope of the present invention.

What is claimed is:

1. A method of clustering a set of records, each of the records having attribute values for a set of attributes, the method comprising:
for each attribute of the set of attributes, determining a characteristic value for said each attribute, based on attribute values of said each attribute;
for each attribute value, determining a deviation from the characteristic value of said each attribute;
for each record, sorting the set of attributes based on deviations of the attribute values, to provide a key; and
clustering the set of records based on the key.

2. The method of claim 1, further comprising calculating a mean value of the attribute values of said each attribute as the characteristic value.

3. The method of claim 1, wherein a median value of the attribute values of said each attribute is determined as the characteristic value.

4. The method of claim 1, wherein determining the deviation comprises calculating a difference between said each attribute value and the characteristic value of said each attribute.

5. The method of claim 1, wherein determining the deviation comprises calculating a difference between said each attribute value and the characteristic value of the corresponding attribute, and dividing the difference by the characteristic value of said each attribute.

6. The method of claim 1, wherein sorting the set of attributes comprises using absolute values of the deviations of the attribute values as a sorting criterion.

7. The method of claim 1, wherein a first record of the set of records contains a first key and a second record of the set of records contains a second key; and
further comprising placing the first key and the second key into a single cluster if the first key and the second key have identical sub-sequences of a first length.

8. The method of claim 1, wherein a first record of the set of records contains a first key and a second record of the set of records contains a second key; and
further comprising placing the first key and the second key into a single cluster if the first key and the second key have identical sub-sequences of absolute values of the deviations.

9. The method of claim 1, wherein a first record of the set of records contains a first key that has a first sub-sequence, and a second record has a second sub-sequence contains a second key; and
further comprising placing the first key and the second key into a single cluster if the first and second sub-sequences comprise the same set of attributes.

10. The method of claim 9, wherein the first and second sub-sequences comprise the same set of attributes irrespective of a sign of the deviations of the attribute values.

11. The method of claim 10, further comprising:
identifying a cluster having a smallest number of records; and
for each record of the identified cluster searching another cluster having records with best matching keys.

12. The method of claim 11, further comprising reducing a length of the first sub-sequence and a length of the second sub-sequence in order to find a best match.

13. The method of claim 12, further comprising using a distance measure to find another cluster for a record of the identified cluster.

14. The method of claim 13, wherein the distance measure comprises a Euclids distance.

15. A computer program product having instruction codes for clustering a set of records, each of the records having attribute values for a set of attributes, the computer program product comprising:
a first set of instruction codes, which, for each attribute of the set of attributes, determines a characteristic value for said each attribute, based on attribute values of said each attribute;
a second set of instruction codes, which, for each attribute value, determines a deviation from the characteristic value of said each attribute;
a third set on instruction codes, which, for each record, sorts the set of attributes based on deviations of the attribute values, to provide a key; and
a fourth set of instruction codes for clustering the set of records based on the key.

16. The computer program product of claim 15, further comprising a fifth set of instruction codes for calculating a mean value of the attribute values of said each attribute as the characteristic value.

17. The computer program product of claim 15, further comprising a sixth set of instruction codes for setting a median value of the attribute values of said each attribute as the characteristic value.

18. The computer program product of claim 15, wherein the second set of instruction codes determines the deviation by calculating a difference between said each attribute value and the characteristic value of said each attribute.

19. The computer program product of claim 15, wherein the second set of instruction codes determines the deviation by calculating a difference between said each attribute value and the characteristic value of the corresponding attribute, and by dividing the difference by the characteristic value of said each attribute.

20. The computer program product of claim 15, wherein the third set on instruction codes sorts the set of attributes using absolute values of the deviations of the attribute values as a sorting criterion.

21. A system for clustering a set of records, each of the records having attribute values for a set of attributes, the system comprising:
each attribute of the set of attributes comprising a characteristic value for said each attribute based on attribute values of said each attribute;
each attribute value comprising a deviation from the characteristic value of said each attribute;
each record comprising the set of attributes based on deviations of the attribute values, to provide a key; and
wherein the set of records are clustered based on the key.

22. The system of claim 21, wherein a mean value of the attribute values of said each attribute is calculated as the characteristic value.

23. The system of claim 21, wherein a median value of the attribute values of said each attribute is calculated as the characteristic value.

24. The system of claim 21, wherein the deviation is calculated as a difference between said each attribute value and the characteristic value of said each attribute.

25. The system of claim 21, wherein the deviation is determined by calculating a difference between said each attribute value and the characteristic value of the corresponding attribute, and by dividing the difference by the characteristic value of said each attribute.

26. The system of claim 21, wherein the set of attributes is sorted using absolute values of the deviations of the attribute values as a sorting criterion.
